(19) United States
(12) Patent Application Publication
(10) Pub. No.: US 2013/0121179 A1
(43) Pub. Date: May 16, 2013

(54) ENHANCED TRANSPORT FORMAT COMBINATION IDENTIFIER SELECTION TO IMPROVE TD-SCDMA HSUPA THROUGHPUT

(71) Applicants: Zhibin Dang, Beijing (CN); Shiau-He Tsai, San Diego, CA (US); Tom Chin, San Diego, CA (US); Jiming Guo, (US)

(72) Inventors: Zhibin Dang, Beijing (CN); Shiau-He Tsai, San Diego, CA (US); Tom Chin, San Diego, CA (US); Jiming Guo, (US)

(73) Assignee: QUALCOMM Incorporated, San Diego, CA (US)

(21) Appl. No.: 13/410,112

(22) Filed: Mar. 1, 2012

Related U.S. Application Data
(60) Provisional application No. 61/560,579, filed on Nov. 16, 2011.

(51) Int. Cl. H04W 24/02

(52) U.S. Cl. 370/252

(57) ABSTRACT

In time division-synchronous code division multiple access high speed uplink packet access (TD-SCDMA HSUPA) communications, a user equipment may select a enhanced physical uplink channel (E-PUCH) modulation scheme based on allocated radio resources. Selection of the modulation scheme is configured to avoid ambiguity at the base station as to which modulation type is selected. Ambiguity may arise in certain communication conditions. Those conditions may be determined and avoided to avoid the ambiguity at the base station.

### CROSS REFERENCE TO RELATED APPLICATION

This application claims the benefit of U.S. Provisional Patent Application No. 61/560,579 filed Nov. 16, 2011, in the names of DANG et al., the disclosure of which is expressly incorporated herein by reference in its entirety.

### BACKGROUND

1. Field

Aspects of the present disclosure relate generally to wireless communication systems, and more particularly, to selecting an enhanced transport format combination identifier (E-TFCI) to improve TD-SCDMA HSUPA (time division-synchronous code division multiple access high speed uplink packet access) throughput.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method of wireless communication. The method includes dynamically determining communication conditions and a range of communication data rates that may lead to an ambiguity at a base station regarding a user equipment (UE) modulation type. The method also includes communicating with the base station outside of the range when the communication conditions are present.

Offered is an apparatus configured for wireless communication. The apparatus includes means for dynamically determining communication conditions and a range of communication data rates that may lead to an ambiguity at a base station regarding a user equipment (UE) modulation type. The apparatus also includes means for communicating with the base station outside of the range when the communication conditions are present.

Offered is a computer program product for wireless communications. The computer program product includes a non-transitory computer-readable medium having program code recorded thereon. The program code includes program code to dynamically determine communication conditions and a range of communication data rates that may lead to an ambiguity at a base station regarding a user equipment (UE) modulation type. The program code also includes program code to communicate with the base station outside of the range when the communication conditions are present.

Offered is an apparatus for wireless communications. The apparatus includes a memory and a processor(s) coupled to the memory. The processor(s) is configured to dynamically determine communication conditions and a range of communication data rates that may lead to an ambiguity at a base station regarding a user equipment (UE) modulation type. The processor(s) is also configured to communicate with the base station outside of the range when the communication conditions are present.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is an illustration of power usage for different modulation orders transmitting with different enhanced transport format combination identifiers (E-TFCIs).

FIG. 5 is a flow diagram illustrating a method for choosing a forbidden set of E-TFCIs according to one aspect of the present disclosure.

FIG. 6 is a flow diagram illustrating a method for selecting an enhanced transport format combination identifier to improve TD-SCDMA HSUPA throughput according to one aspect of the present disclosure.

FIG. 7 is a block diagram illustrating an apparatus for selecting an enhanced transport format combination identifier to improve TD-SCDMA HSUPA throughput according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

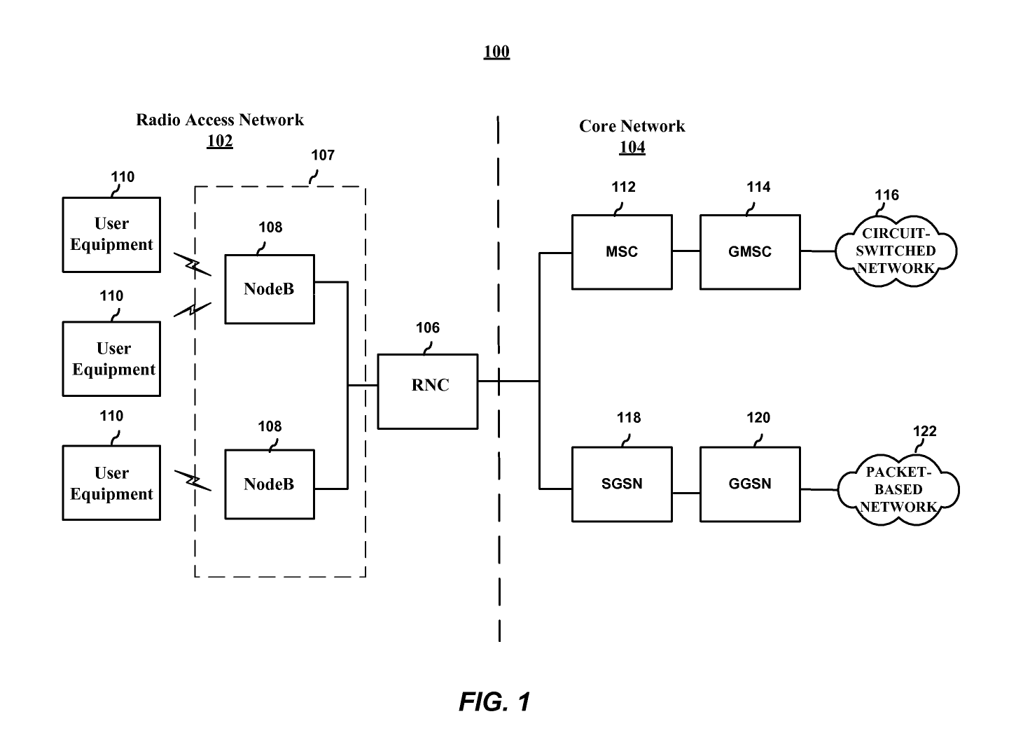

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

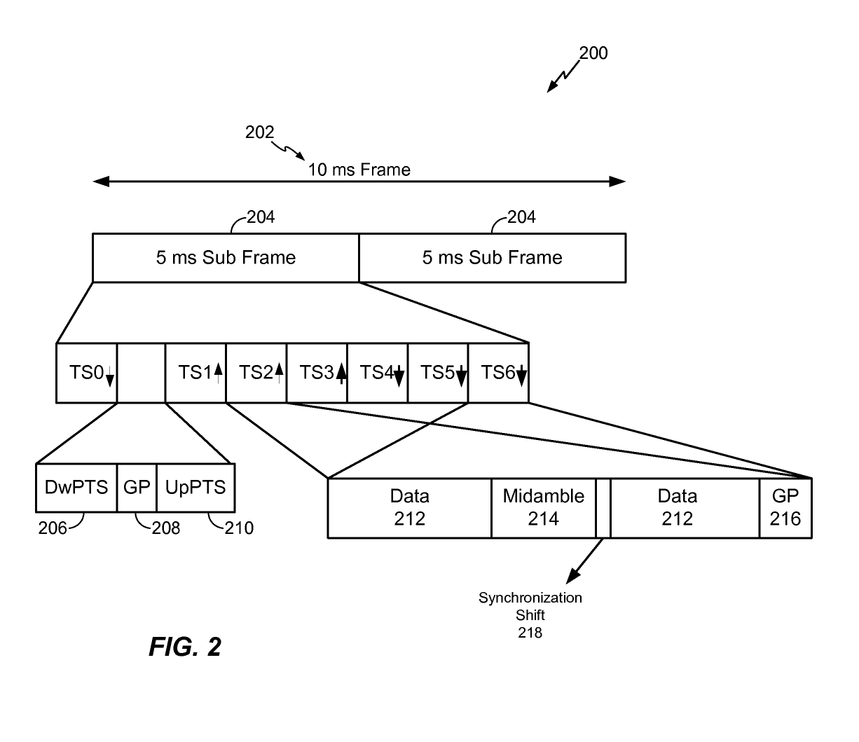

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

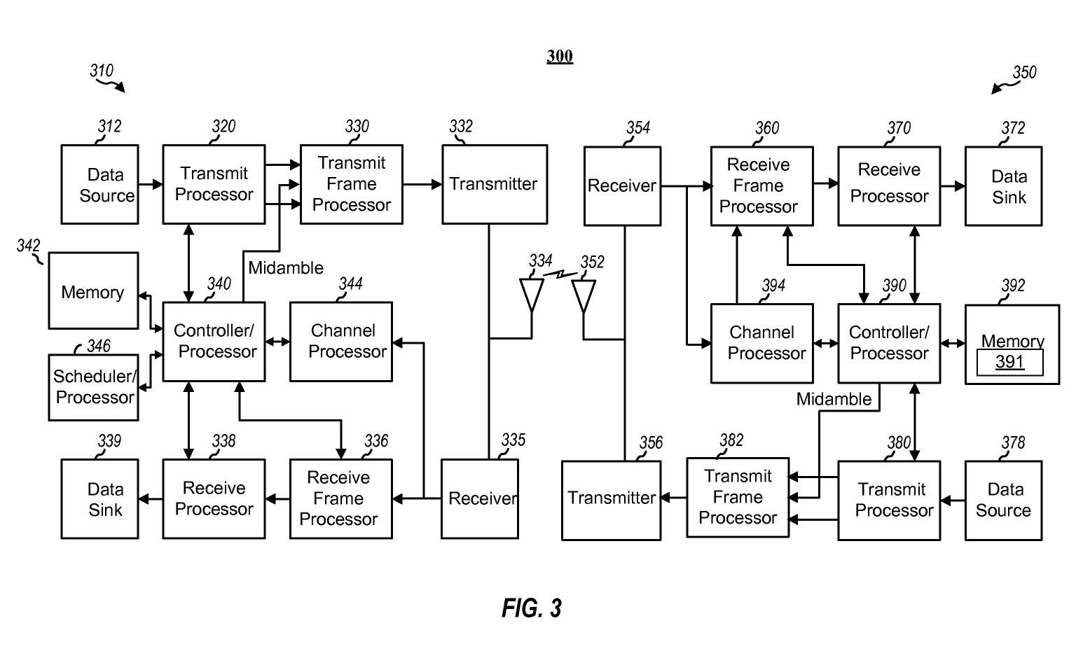

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an enhanced transport format combination identifier (E-TFCI) selection module 391 which, when executed by the controller/processor 390, configures the UE 350 for E-TFCI selection. A scheduler/processor 346 at the node B 310 may be used to allocate resources to the UEs and schedule downlink and/or uplink transmissions for the UEs.

When a user equipment (UE) is communicating with a base station in a time division-synchronous code division multiple access (TD-SCDMA) network during high speed uplink packet access (HSUPA) operation, certain communication conditions may exist which make it difficult for a NodeB to determine the modulation type used by a UE on an enhanced physical uplink channel (E-PUCH). This confusion may lead to uplink throughput loss.

High speed uplink packet access (HSUPA) operation allows a UE to transmit at high data rates upon a scheduling grant from the Node B. A new enhanced dedicated transport channel (E-DCH) is introduced to carry HSUPA data traffic. Four new physical channels are introduced: E-PUCH (enhanced physical uplink channel), E-AGCH (E-DCH absolute grant channel), E-UCCH (E-DCH uplink control channel), and E-HICH (E-DCH HARQ (hybrid automatic repeat request) indicator channel). E-PUCH is the uplink physical channel mapping to E-DCH. E-UCCH is the uplink physical channel carrying control information including E-TFCI and power control. E-AGCH is the downlink physical channel carrying the serving NodeB grant that allocates radio resources of E-PUCH (including power, timeslot and code). E-HICH is the downlink physical channel carrying HARQ acknowledgement/negative acknowledgement (ACK/NACK).

In 3GPP release 7 and corresponding TD-SCDMA HSUPA specifications, the E-PUCH modulation type may be quadrature phase-shift keying (QPSK) or 16-QAM (quadrature amplitude modulation), which is selected by the UE based on uplink radio resources allocated by the NodeB grant. However, the modulation type is not reported to the network directly. Instead, the network derives the E-PUCH modulation type using the enhanced transport format combination identifier (E-TFCI) carried in the E-UCCH and uplink physical configuration information. An E-TFCI is a representation of communication data rate operation.

A user equipment (UE) typically follows three rules when selecting the E-PUCH modulation type:

(1) If an E-TFCI (representing a data rate/block size) only supports either one of QPSK or 16-QAM, then select the supported modulation order;

(2) If an E-TFCI supports both QPSK and 16-QAM, then the modulation order with the lower power requirement (P_{E-PUCH}) is selected; and

(3) QPSK is selected when the E-PUCH is transmitted together with another physical channel in the same timeslot of one transmit time interval (TTI).

Rule 3 has a higher priority than rule 2, which means if the E-PUCH is transmitted with another physical channel, the UE chooses QPSK, regardless of whether QPSK consumes less power than 16-QAM. However the NodeB does not necessarily know when the E-PUCH is being transmitted together with another physical channel. Thus, a potential ambiguity may exist at the NodeB side when determining the modulation type for the E-PUCH.

When determining the modulation type of the E-PUCH, the NodeB calculates the consumed power for QPSK and 16-QAM based on the E-TFCI carried in the E-UCCH, which is defined by equation [1] in the 3GPP TS 25.224 specification:

P_{E-PUCH}=P_{e-base}+L+βₑ (Equation 1)

where P_{e-base} is a closed-loop power quantity maintained by the UE and the NodeB and

L is the path loss.

βₑ is specified by Equation 2 below:

βₑ=β_{0,e}+αₑ+Δ_{harq}dB (Equation 2)

where αₑ is related to the E-PUCH spreading factor (SF_{E-PUCH}) as shown in Table 1:

TABLE 1

| SF_{E-PUCH} | αₑ (dB) |
|---|---|
| 1 | 12 |
| 2 | 9 |
| 4 | 6 |
| 8 | 3 |
| 16 | 0 |

and Δ_{harq} is a HARQ power offset, configured by higher layers.

β_{0,e} is specified by Equation 3 below:

$${β}_{0 , e} = {β}_{λ0} + \frac{{β}_{λ1} - {β}_{λ0}}{{λ}_{1} - {λ}_{0}} ( {λ}_{e} - {λ}_{0} ) dB \\ where {λ}_{e} = \frac{{S}_{e}}{{R}_{e}} , \qquad ( Equation 3 )$$

λ₀, λ₁, β_{λ0} and β_{λ1} are denoted from a reference enhanced transport format combination (E-TFC) configured by the network,

Sₑ is the transport block size of the selected E-TFCI, and

Rₑ is the number of physical channel bits of the E-PUCH, related to the number of E-PUCH timeslots, the spreading factor, and the E-PUCH modulation type.

The network configures minimum and maximum code rates. If λₑ is within that range, it is an available E-TFCI. Otherwise that E-TFCI is blocked by the media access control (MAC) layer. For an available E-TFCI, its potential modulation could be one of three types: only QPSK, only 16-QAM, or potentially either QPSK or 16-QAM. For type 3 E-TFCI, if β_{0,e} of QPSK is greater than that of 16-QAM, then QPSK will consume more power than 16-QAM, and vice versa. Therefore β_{0,e} of transmitting either at QPSK or at 16-QAM is the factor used to determine which modulation type consumes more power.

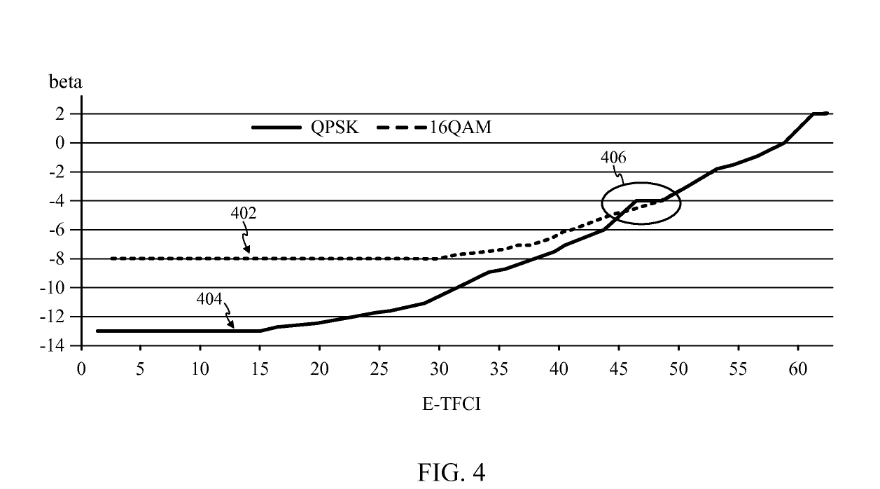

For certain data block sizes, QPSK operation results in a lower power drain, for other data block sizes, 16-QAM results in a lower power drain, and for still other data rates only 16-QAM supports the desired data block size. These communication settings are shown in FIG. 4, with the data block sizes represented by E-TFCI and the power drain represented by beta.

FIG. 4 shows the two modulation order types at different E-TFCI values (representing different data rates/block sizes) graphed against β_{0,e} (representing the power to transmit using a particular modulation order at a particular data rate/block size; called “beta” on the graph). Line 402 illustrates how much power is used for 16-QAM modulation at different E-TFCI values. Line 404 illustrates how much power is used for QPSK modulation at different E-TFCI values. As shown in FIG. 4, between E-TFCI 0 through approximately E-TFCI 45, transmitting using a QPSK modulation consumes less power. Between approximately E-TFCI 45 and E-TFCI 49 (indicated by circle 406), transmitting using a 16-QAM modulation consumes less power. And after approximately E-TFCI 49, only 16-QAM modulation is available.

As indicated by the specification, QPSK is selected if the E-PUCH is transmitted with another physical channel in the same timeslot of one transmit time interval (TTI). Thus, a NodeB should take into consideration the coexistence of the E-PUCH and other physical channels in one time slot. If the UE-selected E-TFCI can be supported by both QPSK and 16-QAM and the NodeB incorrectly determines the modulation order, the NodeB will demodulate E-PUCH incorrectly, which leads to HARQ retransmission and uplink throughput loss.

Specifically, two detection failure scenarios are discussed. In the first scenario, there is coexistence between the uplink physical channel (i.e., E-RUCCH (E-DCH random access uplink control channel), HS-SICH (high speed shared information channel, etc.) and the E-PUCH, meaning an uplink physical channel and the E-PUCH are transmitted in one timeslot. If the UE would normally select an E-TFCI using 16-QAM (as it consumes less power) but is forced to downgrade the E-PUCH to QPSK, then at the NodeB side, if the NodeB fails to detect that an uplink physical channel is active, the NodeB will demodulate the E-PUCH using 16-QAM modulation and cause a decoding failure of the E-PUCH.

In the second detection failure scenario there is coexistence between the dedicated physical channel (DPCH) and the E-PUCH while the DPCH is discontinuously transmitted. If uplink discontinuous transmission is in use, when the UE does not have data to send, the UE can stop DPCH transmission after sending a 10 ms special burst, causing an uplink transmission gap in the DPCH. So even if the DPCH and E-PUCH are configured in one timeslot, the E-PUCH can still use the 16-QAM modulation during a DPCH discontinuous transmission period. If a UE selects an E-TFCI in which 16-QAM consumes less power than QPSK, the E-PUCH transmission will be modulated using 16-QAM. Then, if the NodeB believes the DPCH is still being sent with an outdated configuration and demodulates the E-PUCH with QPSK modulation, an E-PUCH decoding failure will occur.

Both of the above scenarios will led to E-PUCH decoding failure, causing HARQ retransmission and reducing HSUPA data throughput.

Proposed is a method to prevent the above modulation order confusion by only communicating with a base station in a range of communication settings that avoid the potential ambiguity. The method may be based on applying the existing rules for choosing a modulation type and avoiding a range of communication data rates that lead to the NodeB confusion.

When a media access control (MAC) layer selects an E-TFCI for a HARQ new transmission, the MAC layer selects those E-TFCIs allowed by the power-resource-related information (PRRI) in the NodeB grant. The E-PUCH modulation type ambiguity described above is caused by two conditions. First, the network configures the E-PUCH and another physical channel in one timeslot. This causes the NodeB to detect physical channel activity status to avoid the ambiguity. Second, the UE-selected E-TFCI is supported by both QPSK and 16-QAM modulation and QPSK consumes more power than 16-QAM for the selected E-TFCI.

To avoid the ambiguity caused by these conditions and the potential impact to performance, a forbidden E-TFCI set (called SET_F) is created. The UE is then prohibited from operating at an E-TFCI in that null set to prevent NodeB ambiguity. The forbidden set is determined as follows:

1) If the E-PUCH never coexists with another physical channel in one timeslot by network configuration, SET_{—F} is a null set (that is, there is no forbidden communication E-TFCI range)
2) Otherwise, any available E-TFCI that satisfies both conditions a. and b. below is included in SET_F:
a. the E-TFCI is supported by both QPSK and 16-QAM modulation
b. QPSK consumes more power than 16-QAM for that E-TFCI (effectively, this is the range indicated by the circle 406 in FIG. 4).

When SET_F is a null set, the UE can select any available E-TFCI with no restriction.

If the UE determines the E-PUCH may coexist with another physical channel in one timeslot, then the UE never selects an E-TFCI within the range included in SET_F.

SET_F may be dynamically updated every time the UE has a serving grant, for either scheduled or non-scheduled transmission. SET_F is not restricted to several E-TFCI ranges but any E-TFCI satisfying the SET_F rules is included in this set.

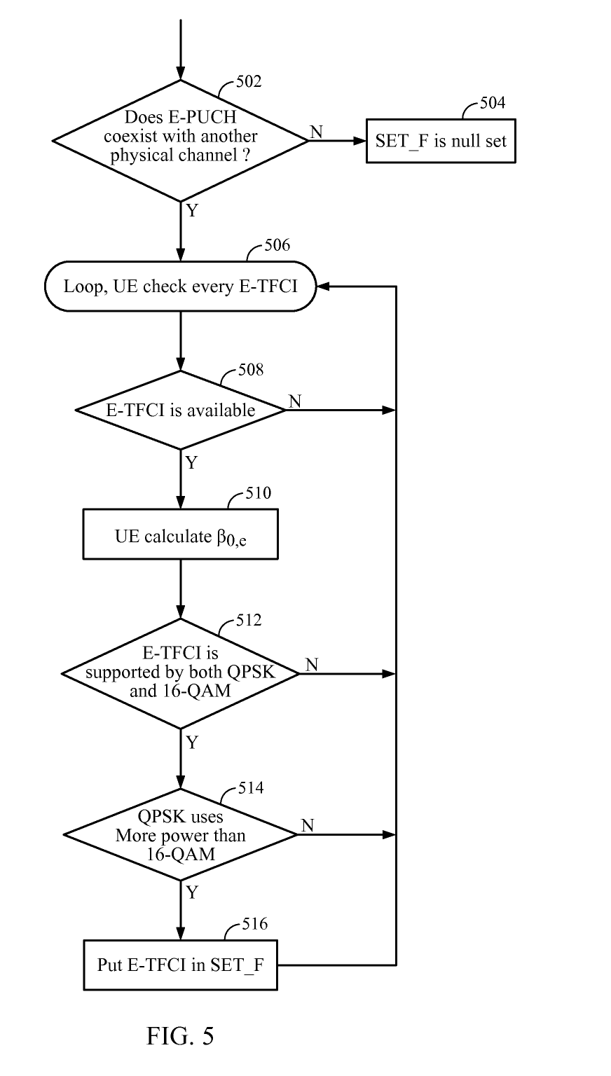

FIG. 5 illustrates an exemplary flow to update SET_F, where β_{0,e} is used to determined the power for a particular modulation scheme.

At block 502 a UE determines if the E-PUCH coexists with another physical channel. If not, SET_F is an empty set, as shown in block 504. If yes, the UE performs a loop and checks each E-TFCI, as shown in block 506. As shown in block 508, if an E-TFCI is unavailable, the process returns to block 506 and the loop continues. Otherwise, if an E-TFCI is available, the UE calculates β_{0,e} for the E-TFCI as shown in block 510.

As shown in block 512, if the E-TFCI is not supported by both QPSK and 16-QAM, the process returns to block 506 and the loop continues. Otherwise, if the E-TFCI is supported by both QPSK and 16-QAM, the UE checks if transmission using QPSK modulation uses more power than transmission using 16-QAM modulation for a particular E-TFCI, as shown in block 514. Otherwise, the process returns to block 506.

If QPSK consumes more power than 16-QAM, then that E-TFCI is placed in the forbidden set SET_F, as shown in block 516. If transmission using QPSK modulation does not consume more power than transmission using 16-QAM, then the loop returns to block 506 and continues for other E-TFCIs.

With the forbidden set SET_F determined, a UE may be forbidden from selecting E-TFCIs in this set, regardless of the whether E-PUCH coexists with another physical channel in a time slot within the transmission time interval. Thus, the range of E-TFCIs that may lead to ambiguity at the NodeB will no longer be used by the UE. Thus, the NodeB will demodulate the E-PUCH with the correct modulation type. This will reduce or eliminate HARQ retransmission caused by modulation type ambiguity between the NodeB and UE, and improve HSUPA data throughput especially for channel coexistence cases.

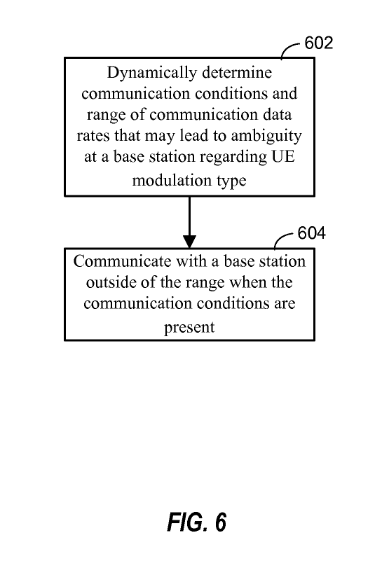

The above proposal may be implemented using an E-TFCI selection module 391. The E-TFCI selection module 391 can be hardware, software, or any combination of the two. High level functionality of the E-TFCI selection module 391 is now described with respect to FIG. 6. As shown in block 602 of FIG. 6, a UE, through the selection module 391, may dynamically determine communication conditions and a range of communication data rates that may lead to ambiguity at a base station regarding a UE modulation type. The UE may also communicate with a base station outside of the range when the communication conditions are present, as shown in block 604.

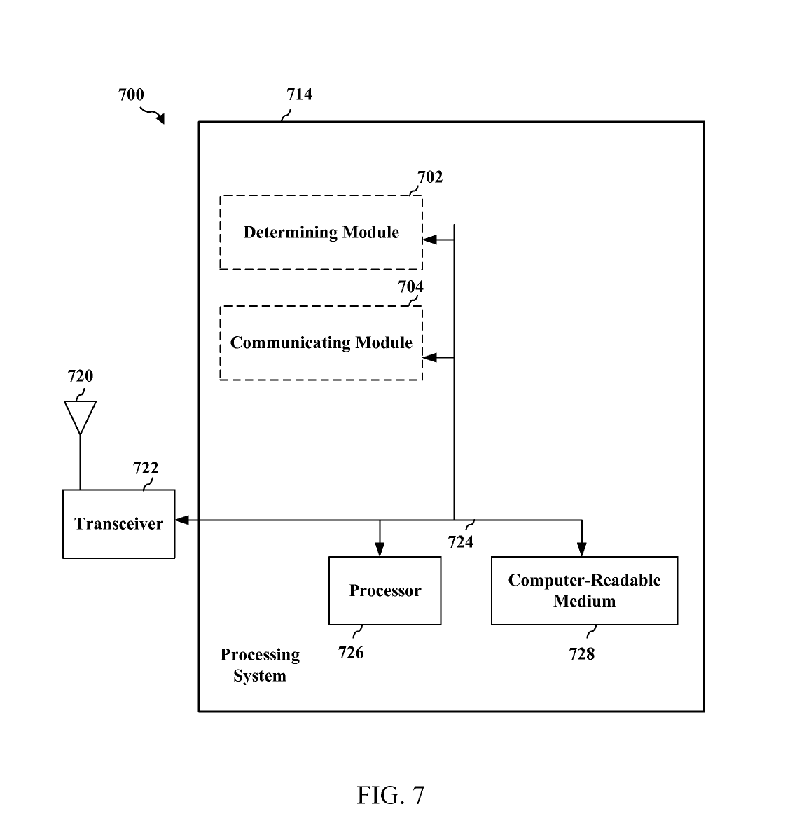

FIG. 7 is a diagram illustrating an example of a hardware implementation for an apparatus 700 employing an E-TFCI selection system 714. The E-TFCI selection system 714 may be implemented with a bus architecture, represented generally by a bus 724. The bus 724 may include any number of interconnecting buses and bridges depending on the specific application of the E-TFCI selection system 714 and the overall design constraints. The bus 724 links together various circuits including one or more processors and/or hardware modules, represented by a processor 726, a determining module 702, a communicating module 704, and a computer-readable medium 728. The bus 724 may also link various other circuits such as timing sources, peripherals, voltage regulators, and power management circuits, which are well known in the art, and therefore, will not be described any further.

The apparatus includes the E-TFCI selection system 714 coupled to a transceiver 722. The transceiver 722 is coupled to one or more antennas 720. The transceiver 722 provides a means for communicating with various other apparatus over a transmission medium. The E-TFCI selection system 714 includes the processor 726 coupled to the computer-readable medium 728. The processor 726 is responsible for general processing, including the execution of software stored on the computer-readable medium 728. The software, when executed by the processor 726, causes the E-TFCI selection system 714 to perform the various functions described supra for any particular apparatus. The computer-readable medium 728 may also be used for storing data that is manipulated by the processor 726 when executing software. The E-TFCI selection system 714 further includes the determining module 702 for determining communication conditions and a range of communication data rates that may lead to ambiguity at a base station regarding a UE modulation type. The E-TFCI selection system 714 further includes the communicating module 704 for communicating with a base station outside of the range when the communication conditions are present. The determining module 702 and the communicating module 704 may be software modules running in the processor 726, resident/stored in the computer readable medium 728, one or more hardware modules coupled to the processor 726, or some combination thereof. The E-TFCI selection system 714 may be a component of the UE 350 and may include the memory 392 and/or the controller/processor 390.

In one configuration, the apparatus 700 for wireless communication includes means for determining. The means may be the determining module 702, the E-TFCI selection module 391, the controller/processor 390, the memory 392, the receive processor 370, the data sink 372, and/or the E-TFCI selection system 714 of the apparatus 700 configured to perform the functions recited by the measuring and recording means. As described above, the E-TFCI selection system 714 may include a processor 726, a bus 724, and/or a computer-readable medium 728. In another aspect, the aforementioned means may be any module or any apparatus configured to perform the functions recited by the aforementioned means.

In one configuration, the apparatus 700 for wireless communication includes means for communicating. The means may be the communicating module 704, the E-TFCI selection module 391, the controller/processor 390, the memory 392, the antenna 720/352, the transceiver 722, the receive processor 370, the transmit processor 380, the receiver 354, the transmitter 356, and/or the E-TFCI selection system 714 of the apparatus 700 configured to perform the functions recited by the measuring and recording means. As described above, the E-TFCI selection system 714 may include a processor 726, a bus 724, and/or a computer-readable medium 728. In another aspect, the aforementioned means may be any module or any apparatus configured to perform the functions recited by the aforementioned means.

Several aspects of a telecommunications system has been presented with reference to TD-SCDMA HSUPA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA 2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication comprising:
dynamically determining communication conditions and a range of communication data rates that may lead to an ambiguity at a base station regarding a user equipment (UE) modulation type; and
communicating with the base station outside of the range when the communication conditions are present.

2. The method of claim 1 in which the ambiguity results from rules governing choice of the UE modulation type.

3. The method of claim 1 in which the communication conditions comprise two simultaneous physical channels coexisting in one timeslot.

4. The method of claim 3 in which one of the physical channels is an enhanced physical uplink channel (E-PUCH).

5. The method of claim 3 in which the communication conditions further comprise:
the range being supported by a plurality of UE modulation types; and
a lower power UE modulation type being unavailable due to currently coexisting physical channels.

6. An apparatus configured for wireless communication comprising:
means for dynamically determining communication conditions and a range of communication data rates that may lead to an ambiguity at a base station regarding a user equipment (UE) modulation type; and
means for communicating with the base station outside of the range when the communication conditions are present.

7. The apparatus of claim 6 in which the ambiguity results from rules governing choice of the UE modulation type.

8. The apparatus of claim 6 in which the communication conditions comprise two simultaneous physical channels coexisting in one timeslot.

9. The apparatus of claim 8 in which one of the physical channels is an enhanced physical uplink channel (E-PUCH).

10. The apparatus of claim 8 in which the communication conditions further comprise:
the range being supported by a plurality of UE modulation types; and
a lower power UE modulation type being unavailable due to currently coexisting physical channels.

11. A computer program product for wireless communication in a wireless network, comprising:
a non-transitory computer-readable medium having non-transitory program code recorded thereon, the non-transitory program code comprising:
program code to dynamically determine communication conditions and a range of communication data rates that may lead to an ambiguity at a base station regarding a user equipment (UE) modulation type; and
program code to communicate with the base station outside of the range when the communication conditions are present.

12. The computer program product of claim 11 in which the ambiguity results from rules governing choice of the UE modulation type.

13. The computer program product of claim 11 in which the communication conditions comprise two simultaneous physical channels coexisting in one timeslot.

14. The computer program product of claim 13 in which one of the physical channels is an enhanced physical uplink channel (E-PUCH).

15. The computer program product of claim 13 in which the communication conditions further comprise:
the range being supported by a plurality of UE modulation types; and
a lower power UE modulation type being unavailable due to currently coexisting physical channels.

16. An apparatus for wireless communication, comprising:
a memory; and
at least one processor coupled to the memory, the at least one processor being configured:
to dynamically determine communication conditions and a range of communication data rates that may lead to an ambiguity at a base station regarding a user equipment (UE) modulation type; and
to communicate with the base station outside of the range when the communication conditions are present.

17. The apparatus of claim 16 in which the ambiguity results from rules governing choice of the UE modulation type.

18. The apparatus of claim 16 in which the communication conditions comprise two simultaneous physical channels coexisting in one timeslot.

19. The apparatus of claim 18 in which one of the physical channels is an enhanced physical uplink channel (E-PUCH).

20. The apparatus of claim 18 in which the communication conditions further comprise:
the range being supported by a plurality of UE modulation types; and
a lower power UE modulation type being unavailable due to currently coexisting physical channels.
